(19) United States
(12) Patent Application Publication
(10) Pub. No.: US 2026/0095933 A1
(43) Pub. Date: Apr. 2, 2026

(54) METHOD AND APPARATUS FOR CONTROLLING LOGICAL CHANNEL PRIORITY FOR DELAY CRITICAL DATA IN MOBILE COMMUNICATION SYSTEM

(71) Applicant: Samsung Electronics Co., Ltd., Suwon-si (KR)

(72) Inventors: Weiping SUN, Suwon-si (KR); Jeongseok YU, Suwon-si (KR); Taeseop LEE, Suwon-si (KR)

(21) Appl. No.: 19/348,415

(22) Filed: Oct. 2, 2025

(30) Foreign Application Priority Data
Oct. 2, 2024 (KR) 10-2024-0133976

(51) Int. Cl. H04W 72/563; H04W 28/06; H04W 28/20; H04W 72/0453

(52) U.S. Cl. CPC H04W 72/563; H04W 28/06; H04W 28/20; H04W 72/0453

(57) ABSTRACT

The disclosure relates to a 5G or 6G communication system for supporting a higher data transmission rate. The disclosure provides a method and an apparatus for controlling logical channel prioritization for delay-critical data in a wireless communication system. The method of a terminal comprises: receiving, from a base station, a message comprising information on a priority for a logical channel, information on an additional priority for the logical channel, and information on a threshold for determining whether the additional priority is applied to the logical channel; determining whether uplink data buffered on the logical channel includes a remaining time before discard falling below the threshold; and based on a determination that the uplink data includes the remaining time before discard falling below the threshold, applying the additional priority of the logical channel.

### CROSS-REFERENCE TO RELATED APPLICATION

This application is based on and claims priority under 35 U.S.C. § 119 to Korean Patent Application No. 10-2024-0133976, filed on Oct. 2, 2024, in the Korean Intellectual Property Office, the disclosure of which is herein incorporated by reference in its entirety.

### BACKGROUND

### 1. Field

The disclosure relates to a method and an apparatus for controlling logical channel priority for delay-critical data in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NRU) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with respect to the disclosure.

### SUMMARY

An embodiment of the disclosure is to provide a method and an apparatus for controlling logical channel priority for delay-critical data in a wireless communication system.

The technical subjects pursued in the disclosure may not be limited to the above-mentioned technical subjects, and other technical subjects which are not mentioned herein may be clearly understood from the following description by those skilled in the art to which the disclosure pertains.

In accordance with an aspect of the disclosure, a method performed by a terminal in a wireless communication system is provided. The method comprises receiving, from a base station, a message comprising information on a priority for a logical channel, information on an additional priority for the logical channel, and information on a threshold for determining whether the additional priority is applied for the logical channel; determining whether a remaining time of a packet data convergence protocol (PDCP) service data unit (SDU) of the logical channel is less than the threshold; in case that the remaining time of the PDCP SDU of the logical channel is less than the threshold, applying the additional priority of the logical channel.

In an embodiment, the applying the additional priority further comprises: allocating resources to logical channels with Bj>0 in a decreasing priority order, wherein the Bj is a variable for each logical channel j; decreasing the Bj by a total size of medium access control (MAC) SDUs served to the logical channel j; in case that any resource remain, determining whether the logical channel does not have any uplink data having the remaining time before discard falling below the threshold; in case that the logical channel does not have any uplink data having the remaining time before discard falling below the threshold, applying the priority of the logical channel; and allocating resources to logical channels in a strict deceasing priority order regardless of the Bj until either a data for a logical channel or an uplink grant is exhausted.

In an embodiment, a reception of the message further comprises: transmitting, to the base station, information indicating that the terminal supports the additional priority for the logical channel.

In an embodiment, the information on the priority, the information on the additional priority, and the information on the threshold are included in logical channel configuration information.

In accordance with an aspect of the disclosure, a method performed by a base station in a wireless communication system is provided. The method comprises transmitting, to a terminal, a message comprising information on a priority for a logical channel, information on an additional priority for the logical channel, and information on a threshold for determining whether the additional priority is applied for the logical channel; and receiving, from the terminal, uplink data based on a priority order of logical channels, wherein, in case that a remaining time of a packet data convergence protocol (PDCP) service data unit (SDU) of the logical channel is less than the threshold, the additional priority of the logical channel is applied.

In an embodiment, logical channels with Bj>0 are allocated resources in a decreasing priority order, the Bj is a variable for each logical channel j, and the Bj is decreased by a total size of medium access control (MAC) SDUs served to the logical channel j.

In an embodiment, in case that any resource remain and the logical channel does not have any uplink data having the remaining time before discard falling below the threshold, the priority of the logical channel is applied.

In an embodiment, logical channels are allocated resources in a strict deceasing priority order regardless of the Bj until either a data for a logical channel or an uplink grant is exhausted.

In an embodiment, a transmission of the message further comprises: receiving, from the terminal, information indicating that the terminal supports the additional priority for the logical channel.

In accordance with an aspect of the disclosure, a terminal in a wireless communication system is provided. The terminal comprises a transceiver; and a controller coupled with the transceiver and configured to: receive, from a base station, a message comprising information on a priority for a logical channel, information on an additional priority for the logical channel, and information on a threshold for determining whether the additional priority is applied for the logical channel, determine whether a remaining time of a packet data convergence protocol (PDCP) service data unit (SDU) of the logical channel is less than the threshold, and in case that the remaining time of the PDCP SDU of the logical channel is less than the threshold, apply the additional priority of the logical channel.

In accordance with an aspect of the disclosure, a base station in a wireless communication system is provided. The base station comprises a transceiver; and a controller coupled with the transceiver and configured to: transmit, to a terminal, a message comprising information on a priority for a logical channel, information on an additional priority for the logical channel, and information on a threshold for determining whether the additional priority is applied for the logical channel, and receive, from the terminal, uplink data based on a priority order of logical channels, wherein, in case that a remaining time of a packet data convergence protocol (PDCP) service data unit (SDU) of the logical channel is less than the threshold, the additional priority of the logical channel is applied.

According to an embodiment of the disclosure, it is possible to provide a method and an apparatus for controlling logical channel priority for delay-critical data in a wireless communication system.

Advantageous effects obtainable from the disclosure may not be limited to the above-mentioned effects, and other effects which are not mentioned herein may be clearly understood from the following description by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a structure of an NR system according to an embodiment of the disclosure;

FIG. 2 illustrates an example of a radio protocol structure in an NR system according to an embodiment of the disclosure;

FIG. 3 illustrates an example of a procedure in which a UE establishes a connection with a network according to an embodiment of the disclosure;

FIG. 4 illustrates an example of a case in which DC-priority is applied to a logical channel according to an embodiment of the disclosure;

FIG. 5 illustrates an example of an operation in which a base station indicates whether to apply DC-priority to a specific logical channel of a UE according to an embodiment of the disclosure;

FIG. 6 illustrates an example of a structure of a UE according to an embodiment of the disclosure; and

FIG. 7 illustrates an example of a structure of a network entity according to an embodiment of the disclosure.

### DETAILED DESCRIPTION

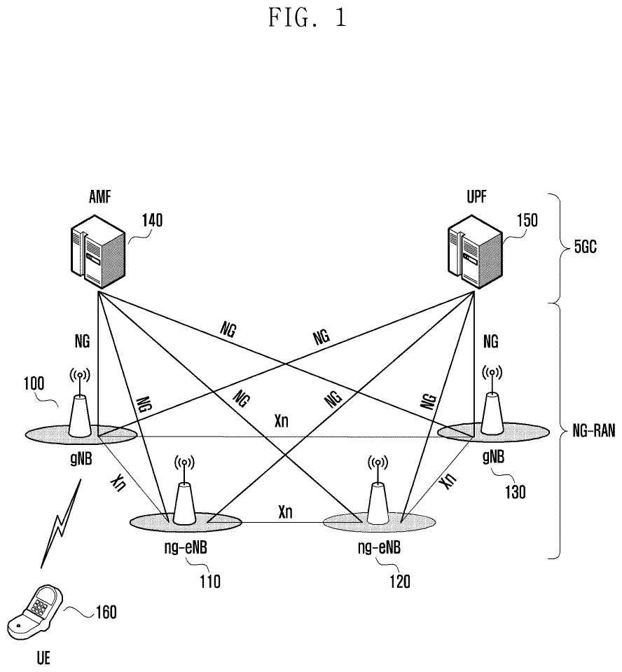

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail in conjunction with the accompanying drawings. In describing the disclosure below, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the disclosure below, a detailed description of known functions or configurations will be omitted when it is determined that the description may make the subject matter of the disclosure unnecessarily unclear. Hereinafter, embodiments of the disclosure will be described with reference to the accompanying drawings.

Hereinafter, the operation principle of the disclosure will be described in detail in conjunction with the accompanying drawings. The terms which will be described below are terms defined in consideration of the functions in the disclosure. They may be different according to users, intentions of the users, or customs, and therefore, the definitions of the terms should be made based on the contents throughout the specification.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. Moreover, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform with other standards.

Particular terms as used in the following description are merely provided to help understanding of the disclosure, and other types of terms may be used without departing from the scope of the technical idea of the disclosure.

FIG. 1 illustrates an example of a structure of an NR system according to an embodiment of the disclosure.

Referring to FIG. 1, a wireless communication system may include multiple base stations (e.g., a gNB 100, an ng-eNB 110, an ng-eNB 120, and a gNB 130), an access and mobility management function (AMF) 140, and a user plane function (UPF) 150. The wireless communication system is not limited by the structure illustrated in FIG. 1, and may include a larger or smaller number of components than those of the structure in FIG. 1.

According to an embodiment of the disclosure, a user equipment (hereinafter UE or terminal) 160 may access an external network via the base stations 100, 110, 120, and 130 and the UPF 150.

In FIG. 1, the base stations 100, 110, 120, and 130 may provide radio access to UEs 160 that access the cellular network as network access nodes. For example, in order to service users' traffic, the base stations 100, 110, 120, and 130 may collect at least one piece of state information of the UEs 160, such as buffer states, available transmission power states, or channel states, and perform scheduling accordingly. The base stations 100, 110, 120, and 130 may support connections between the UEs and the core network (CN). The CN of NR may refer to a 5th generation core network (5GC).

The gNBs 100 and 130 may control multiple cells. The gNBs 100 and 130 may employ an adaptive modulation and coding (hereinafter AMC) scheme for determining a modulation scheme and a channel coding rate according to a channel state of the UE 160.

The core network may be a device responsible for various control functions, as well as a mobility management function for the UEs 160. The core network may be connected to multiple base stations. Also, the 5GC may interwork with the LTE system.

A wireless communication system may be divided into a user plane (hereinafter UP) associated with actual user data transfer and a control plane (hereinafter CP) such as connection management. The gNB 100 and gNB 130 may use UP and CP techniques defined in the NR technology. The ng-eNB 110 and ng-eNB 120 may use UP and CP techniques defined in the LTE technology.

The AMF 140 may perform a mobility management function for the UE 160. The AMF 140 is a device responsible for various control functions and may be connected to multiple base stations.

The UPF 130 may refer to a gateway device for providing data transmission. The NR communication system may include a session management function (SMF). The SMF may manage a packet data network connection, such as a protocol data unit (PDU) session, provided to the UE 160.

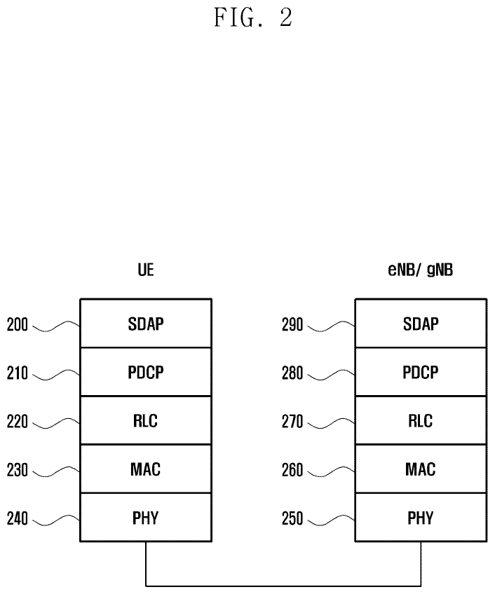

FIG. 2 illustrates an example of a radio protocol structure in an NR system according to an embodiment of the disclosure.

Referring to FIG. 2, a radio protocol of an NR system may include at least one of a service data adaptation protocol (SDAP) 200, a packet data convergence protocol (PDCP) 210, a radio link control (RLC) 220, a medium access control (MAC) 230, or a physical (PHY) 240 on a UE side.

The radio protocol of the NR system may include at least one of an SDAP 290, a PDCP 280, an MAC 260, or a PHY 250 on a base station side.

In the following, the SDAP, the PDCP, the RLC, the MAC, the PHY, and the RRC may be interchangeably used with and have the same meaning as the terms “SDAP layer,” “PDCP layer,” “RLC layer,” “MAC layer,” “PHY layer,” and “RRC layer” respectively.

The SDAP 200 or 290 may transfer user data. The SDAP 200 or 290 may perform at least one of an operation for mapping a QoS flow to a specific DRB for both uplink and downlink, operation for marking a QoS flow ID for both uplink and downlink, or an operation for mapping a reflective QoS flow to a data bearer for uplink SDAP PDUs. An SDAP configuration corresponding to each DRB may be provided from a higher RRC layer. However, they are merely an example, and the operations or functions of the SDAP are not limited thereto.

The PDCP 210 or 280 may perform operations such as IP header compression/reconstruction. Also, the PDCP 210 or 280 may provide at least one of an in-sequence delivery function, an out-of-sequence delivery function, a reordering function, a retransmission function, or a ciphering and deciphering function. However, they are merely an example, and the operations or functions of the PDCP are not limited thereto.

The RLC 220 or 270 may reconfigure a PDCP PDU into appropriate sizes. The RLC 220 or 270 may provide at least one of an in-sequence delivery function, an out-of-sequence delivery function, an automatic repeat request (ARQ) function, a concatenation, segmentation, and reassembly function, a re-segmentation function, a reordering function, a duplicate detection function, or an error detection function. However, they are merely an example, and the operations or functions of the RLC are not limited thereto.

The MAC 230 or 260 may be connected to several RLC layer devices configured in a single UE. The MAC 230 or 260 may perform at least one of an operation of multiplexing RLC PDUs into an MAC PDU or an operation of demultiplexing RLC PDUs from an MAC PDU. The MAC 230 or 260 may provide at least one of a mapping function, a scheduling information reporting function, an HARQ function, a priority handling function between logical channels, a priority handling function between UEs, an MBMS service identification function, a transport format selection function, or a padding function. However, they are merely an example, and the operations or functions of the MAC are not limited thereto.

The PHY 240 or 250 may perform channel-coding and modulation of upper layer data to obtain orthogonal frequency division multiplexing (OFDM) symbols, and deliver the OFDM symbols through a radio channel. The PHY 240 or 250 may demodulate OFDM symbols received through a radio channel, perform channel-decoding thereof, and deliver the same to the upper layer. For additional error correction, the PHY layer may also use HARQ. A receiving end may use one bit to transmit whether a packet transmitted by a transmitting end is received. This 1-bit information may be HARQ acknowledgement (ACK)/negative acknowledgement (NACK) information.

In the case of LTE, downlink HARQ ACK or NACK information in response to uplink data transmission may be transmitted via a physical hybrid-ARQ indicator channel (PHICH). In the case of NR, whether retransmission may be performed or new transmission is to be performed may be determined through UE scheduling information via a physical dedicated control channel (PDCCH) that is a channel via which downlink or uplink resource allocation and the like are transmitted This is because asynchronous HARQ may be applied in NR.

Uplink HARQ ACK or NACK information in response to downlink data transmission may be transmitted via a physical uplink control channel (PUCCH) or a physical uplink shared channel (PUSCH). The PUCCH may be transmitted in an uplink of a primary cell (PCell). If supported by a UE, the PUCCH may be transmitted in a secondary cell (SCell) as described below, which is referred to as a PUCCH SCell. For example, if supported by a UE, the PUCCH may be transmitted from the UE to a base station in an uplink of an SCell. Here, the SCell may refer to a physical uplink control channel (PUCCH) SCell.

A radio resource control (RRC) layer (not illustrated) may exist as a higher layer than each PDCP layer of the UE and the base station. The RRC layer may exchange access and/or measurement-related configuration control messages for radio resource control.

The PHY layer may include one or multiple frequencies or carriers. A technology for simultaneously configuring and using multiple frequencies may refer to carrier aggregation (hereinafter CA). One carrier may be used for communication between a UE and a base station (eNB or gNB). In the case of using the CA technology, one primary carrier and one or multiple secondary carriers may be used for communication between a UE and a base station. In this case, the amount of data transfer may be increased as much as the number of increased secondary carriers. In LTE or NR, a cell in a base station, which uses the primary carrier, may refer to a primary cell or PCell. In LTE or NR, a cell in a base station, which uses the secondary subcarriers, may refer to a secondary cell or SCell.

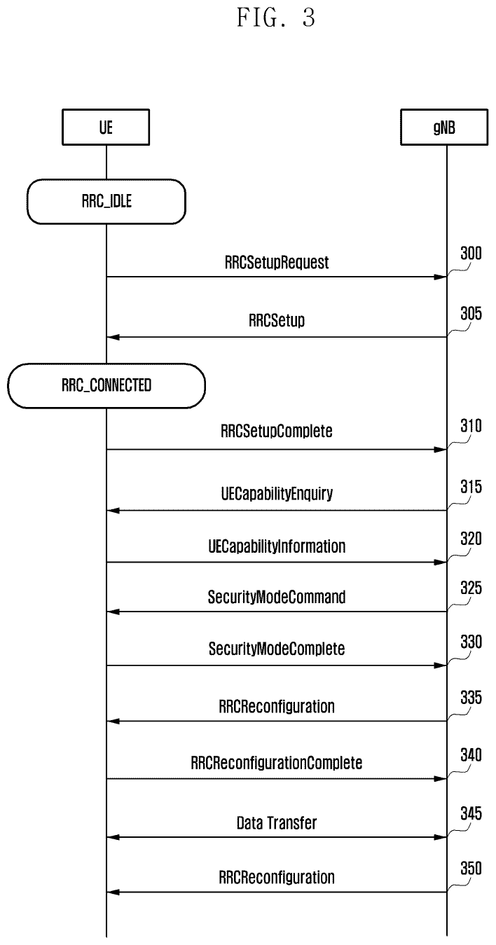

FIG. 3 illustrates an example of a procedure in which a UE establishes an RRC connection with a base station according to an embodiment of the disclosure.

Referring to FIG. 3, in the disclosure, a UE may switch from an RRC idle mode (RRC_IDLE) to an RRC connected mode (RRC_CONNECTED) to establish a connection with a network. The UE may establish uplink or downlink transmission synchronization with the base station through a random access procedure. The UE may transmit an RRCSetupRequest message to the base station (operation 300). The RRCSetupRequest message may include an identifier of the UE or a connection establishment cause (e.g., EstablishmentCause). The base station may transmit an RRCSetup message to the UE to enable the UE to establish the RRC connection (operation 305).

In an embodiment of the disclosure, the RRCSetup message may include configuration information (e.g., CellGroupConfig IE) for each cell group (e.g., at least one of a master cell group (MCG) or a secondary cell group (SCG)).

In an embodiment of the disclosure, a UE that has established the RRC connection may enter the RRC_CONNECTED mode. The UE may transmit an RRCSetupComplete message to the base station (operation 310).

In an embodiment of the disclosure, when the base station does not know the capability of the UE currently establishing the connection, or when it is necessary to identify the UE capability, the base station may transmit a message inquiring about the capability of the UE (e.g., UECapabilityEnquiry) to the UE (operation 315).

In an embodiment of the disclosure, the UE may transmit, to the base station, a message for reporting its capability (e.g., UECapabilityInformation) (operation 320).

In an embodiment of the disclosure, the base station may transmit a SecurityModeCommand message to the UE to establish security with the UE (operation 325). The UE may transmit a SecurityModeComplete message to the base station (operation 330).

In an embodiment of the disclosure, when security setting is completed, the base station may transmit an RRCReconfiguration message to the UE (operation 335). The UE may then transmit an RRCReconfigurationComplete message to the base station (operation 340). The UE and the base station may perform data transfer in operation 345. Further, according to another embodiment, the base station may transmit an additional RRCReconfiguration message to the UE (operation 350).

In an embodiment of the disclosure, the RRCReconfiguration message may include configuration information (e.g., CellGroupConfig IE) for each cell group (e.g., at least one of an MCG or an SCG).

In an embodiment of the disclosure, the configuration information for each cell group (e.g., CellGroupConfig IE) may have a structure as shown in [Table 1] below. For example, the CellGroupConfig IE may include at least one of the fields/information included in [Table 1]. For example, one cell group may include at least one of one MAC entity, one or more RLC bearers, one or multiple primary cells, and one or multiple secondary cells. For example, one RLC bearer may include one RLC entity and one logical channel associated with the RLC entity. For example, the configuration information for each cell group (e.g., CellGroupConfig IE) may include configuration information for each RLC bearer (e.g., RLC-BearerConfig).

TABLE 1

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC-BearerConfig |
| OPTIONAL, -- Need N | |
| rlc-BearerToReleaseList | SEQUENCE (SIZE(1..maxLC-ID)) OF |
| LogicalChannelIdentity | OPTIONAL, -- Need N |
| mac-CellGroupConfig | MAC-CellGroupConfig |
| OPTIONAL, -- Need M | |
| physicalCellGroupConfig | PhysicalCellGroupConfig |
| OPTIONAL, -- Need M | |
| spCellConfig | SpCellConfig |
| OPTIONAL, -- Need M | |
| sCellToAddModList | SEQUENCE (SIZE(1..maxNrofSCells)) OF SCellConfig |
| OPTIONAL, -- Need N | |
| sCellToReleaseList | SEQUENCE (SIZE(1..maxNrofSCells)) OF SCellIndex |
| OPTIONAL, -- Need N | |
| ..., | |
| [[ | ENUMERATED {true} |
| reportUplinkTxDirectCurrent | |
| OPTIONAL -- Cond BWP-Reconfig | |
| ]], | |
| [[ | |
| bap-Address-r16 | BIT STRING (SIZE (10)) |
| OPTIONAL, -- Need M | |
| bh-RLC-ChannelToAddModList-r16 | SEQUENCE (SIZE(1..maxBH-RLC-ChannelID-r16)) OF BH- |
| RLC-ChannelConfig-r16 OPTIONAL, -- Need N | |
| bh-RLC-ChannelToReleaseList-r16 | SEQUENCE (SIZE(1..maxBH-RLC-ChannelID-r16)) OF BH- |
| RLC-ChannelID-r16 OPTIONAL, -- Need N | |
| f1c-TransferPath-r16 | ENUMERATED {lte, nr, both} |
| OPTIONAL, -- Need M | |
| simultaneousTCI-UpdateList1-r16 | SEQUENCE (SIZE (1..maxNrofServingCellsTCI-r16)) OF |
| ServCellIndex OPTIONAL, -- Need R | |
| simultaneousTCI-UpdateList2-r16 | SEQUENCE (SIZE (1..maxNrofServingCellsTCI-r16)) OF |
| ServCellIndex OPTIONAL, -- Need R | |
| simultaneousSpatial-UpdatedList1-r16 | SEQUENCE (SIZE (1..maxNrofServingCellsTCI-r16)) OF |
| ServCellIndex OPTIONAL, -- Need R | |
| simultaneousSpatial-UpdatedList2-r16 | SEQUENCE (SIZE (1..maxNrofServingCellsTCI-r16)) OF |
| ServCellIndex OPTIONAL, -- Need R | |
| uplinkTxSwitchingOption-r16 | ENUMERATED {switchedUL, dualUL} |
| OPTIONAL, -- Need R | |
| uplinkTxSwitchingPowerBoosting-r16 | ENUMERATED {enabled} |
| OPTIONAL -- Need R | |
| ]], | |
| [[ | |
| reportUplinkTxDirectCurrentTwoCarrier-r16 | ENUMERATED {true} |
| OPTIONAL -- Need N | |
| ]], | |
| [[ | |
| flc-TransferPathNRDC-r17 | ENUMERATED {mcg, scg, both} |
| OPTIONAL, -- Need M | |
| uplinkTxSwitching-2T-Mode-r17 | ENUMERATED {enabled} |
| OPTIONAL, -- Cond 2Tx | |
| uplinkTxSwitching-DualUL-TxState-r17 | ENUMERATED {oneT, twoT} |
| OPTIONAL, -- Cond 2Tx | |
| uu-RelayRLC-ChannelToAddModList-r17 | SEQUENCE (SIZE(1..maxUu-RelayRLC-ChannelID-r17)) |
| OF Uu-RelayRLC-ChannelConfig-r17 | |
| OPTIONAL, -- Need N | |
| uu-RelayRLC-ChannelToReleaseList-r17 | SEQUENCE (SIZE(1.. maxUu-RelayRLC-ChannelID-r17)) |
| OF Uu-RelayRLC-ChannelID-r17 | |
| OPTIONAL, -- Need N | |
| simultaneousU-TCI-UpdateList1-r17 | SEQUENCE (SIZE (1..maxNrofServingCellsTCI-r16)) OF |
| ServCellIndex OPTIONAL, -- Need R | |
| simultaneousU-TCI-UpdateList2-r17 | SEQUENCE (SIZE (1..maxNrofServingCellsTCI-r16)) OF |
| ServCellIndex OPTIONAL, -- Need R | |
| simultaneousU-TCI-UpdateList3-r17 | SEQUENCE (SIZE (1..maxNrofServingCellsTCI-r16)) OF |
| ServCellIndex OPTIONAL, -- Need R | |
| simultaneousU-TCI-UpdateList4-r17 | SEQUENCE (SIZE (1..maxNrofServingCellsTCI-r16)) OF |
| ServCellIndex OPTIONAL, -- Need R | |
| rlc-BearerToReleaseListExt-r17 | SEQUENCE (SIZE(1..maxLC-ID)) OF |
| LogicalChannelIdentityExt-r17 | OPTIONAL, -- Need N |
| iab-ResourceConfigToAddModList-r17 | SEQUENCE (SIZE(1..maxNrofIABResourceConfig-r17)) OF IAB- |
| ResourceConfig-r17 OPTIONAL, -- Need N | |
| iab-ResourceConfigToReleaseList-r17 | SEQUENCE (SIZE(1..maxNrofIABResourceConfig-r17)) OF IAB- |
| ResourceConfigID-r17 OPTIONAL -- Need N | |
| ]], | |
| [[ | |
| reportUplinkTxDirectCurrentMoreCarrier-r17 | ReportUplinkTxDirectCurrentMoreCarrier-r17 |
| OPTIONAL -- Need N | |
| ]], | |
| [[ | |
| prioSCellPRACH-OverSP-PeriodicSRS-r17 | ENUMERATED {enabled} |
| OPTIONAL -- Need R | |
| ]], | |
| [[ | |
| ncr-FwdConfig-r18 | SetupRelease { NCR-FwdConfig-r18 } |
| OPTIONAL, -- Cond NCR | |
| autonomousDenialParameters-r18 | SetupRelease {AutonomousDenialParameters-r18} |
| OPTIONAL, -- Need M | |
| nonCollocatedTypeMRDC-r18 | ENUMERATED { true } |
| OPTIONAL, -- Need R | |
| nonCollocatedTypeNR-CA-r18 | ENUMERATED { true } |
| OPTIONAL, -- Need R | |
| uplinkTxSwitchingMoreBands-r18 | SetupRelease { UplinkTxSwitchingMoreBands-r18 } |
| OPTIONAL -- Need M | |
| ]] | |
| } | |

In an embodiment of the disclosure, the configuration information for each RLC bearer (e.g., RLC-BearerConfig IE) may have a structure as shown in Table 2 below. For example, the RLC-BearerConfig IE may include at least one of the fields/information included in Table 2.

TABLE 2

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |
| } | |
| OPTIONAL, -- Cond LCH-SetupOnly | |
| reestablishRLC | ENUMERATED {true} |
| OPTIONAL, -- Need N | |
| rlc-Config | RLC-Config |
| OPTIONAL, -- Cond LCH-Setup | |
| mac-LogicalChannelConfig | LogicalChannelConfig |
| OPTIONAL, -- Cond LCH-Setup | |
| ..., | |
| [[ | |
| rlc-Config-v1610 | RLC-Config-v1610 |
| OPTIONAL -- Need R | |
| ]], | |
| [[ | |
| rlc-Config-v1700 | RLC-Config-v1700 |
| OPTIONAL, -- Need R | |
| logicalChannelIdentityExt-r17 | LogicalChannelIdentityExt-r17 |
| OPTIONAL, -- Cond LCH-SetupModMRB | |
| multicastRLC-BearerConfig-r17 | MulticastRLC-BearerConfig-r17 |
| OPTIONAL, -- Cond LCH-SetupOnlyMRB | |
| servedRadioBearerSRB4-r17 | SRB-Identity-v1700 |
| OPTIONAL -- Need N | |
| ]] | |
| } | |
| MulticastRLC-BearerConfig-r17 ::= | SEQUENCE { |
| servedMBS-RadioBearer-r17 | MRB-Identity-r17, |
| isPTM-Entity-r17 | ENUMERATED {true} |
| OPTIONAL -- Need S | |
| } | |
| LogicalChannelIdentityExt-r17 ::= | INTEGER (320..65855) |

In an embodiment of the disclosure, the configuration information for the RLC bearer (e.g., RLC-BearerConfig IE) may include configuration information for a logical channel (e.g., LogicalChannelConfig) associated with the corresponding RLC entity. For example, the logical channel configuration information (e.g., LogicalChannelConfig) may have a structure as shown in Table 3 below. For example, the LogicalChannelConfig IE may include at least one of the fields/information included in Table 3.

TABLE 3

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, KBps32, kBps64, |
| kBps128, KBps256, kBps512, | |
| | kBps1024, kBps2048, kBps4096, kBps8192, kBps16384, |
| KBps32768, kBps65536, infinity}, | |
| bucketSizeDuration | ENUMERATED {ms5, ms10, ms20, ms50, ms100, ms150, |
| ms300, ms500, ms1000, | |
| | spare7, spare6, spare5, spare4, |
| spare3, spare2, spare1}, | |
| allowedServingCells | SEQUENCE (SIZE (1..maxNrofServingCells-1)) OF |
| ServCellIndex | |
| OPTIONAL, -- Cond PDCP-CADuplication | |
| allowedSCS-List | SEQUENCE (SIZE (1..maxSCSs)) OF SubcarrierSpacing |
| OPTIONAL, -- Need R | |
| maxPUSCH-Duration | ENUMERATED {ms0p02, ms0p04, ms0p0625, ms0p125, |
| ms0p25, ms0p5, ms0p01-v1700, spare1} | |
| OPTIONAL, -- Need R | |
| configuredGrantType1Allowed | ENUMERATED {true} |
| OPTIONAL, -- Need R | |
| logicalChannelGroup | INTEGER (0..maxLCG-ID) |
| OPTIONAL, -- Need R | |
| schedulingRequestID | SchedulingRequestId |
| OPTIONAL, -- Need R | |
| logicalChannelSR-Mask | BOOLEAN, |
| logicalChannelSR-DelayTimerApplied | BOOLEAN, |
| ..., | |
| bitRateQueryProhibitTimer | ENUMERATED {s0, s0dot4, s0dot8, s1dot6, s3, s6, s12, s30} |
| OPTIONAL, -- Need R | |
| [[ | |
| allowedCG-List-r16 | SEQUENCE (SIZE (0..maxNrofConfiguredGrantConfigMAC- |
| 1-r16)) OF ConfiguredGrantConfigIndexMAC-r16 | |
| OPTIONAL, -- Need S | |
| allowedPHY-PriorityIndex-r16 | ENUMERATED {p0, p1} |
| OPTIONAL -- Need S | |
| ]], | |
| [[ | |
| logicalChannelGroupIAB-Ext-r17 | INTEGER (0..maxLCG-ID-IAB-r17) |
| OPTIONAL, -- Need R | |
| allowedHARQ-mode-r17 | ENUMERATED {harqModeA, harqModeB} |
| OPTIONAL -- Need R | |
| ]] | |
| } | |
| OPTIONAL, -- Cond UL | |
| ..., | |
| [[ | |
| channelAccessPriority-r16 | INTEGER (1..4) |
| OPTIONAL, -- Need R | |
| bitRateMultiplier-r16 | ENUMERATED {x40, x70, x100, x200} |
| OPTIONAL -- Need R | |
| ]] | |
| } | |

In an embodiment of the disclosure, the base station may configure the priority of a corresponding logical channel in a corresponding cell group of a corresponding UE using the priority field/information (1 to 16) of the LogicalChannelConfig IE. In an embodiment of the disclosure, the base station may configure one or multiple additional priorities for the logical channel in the corresponding cell group of the UE, in addition to the priority configured through the priority field/information. In the disclosure, the priority configured through the priority field may be referred to as the default priority of the logical channel, and to distinguish from the default priority, the additionally configured priority may be referred to as a delay critical priority (DC-priority). However, the terms default priority and DC-priority are merely exemplary, and the disclosure does not limit the naming of the priorities. In an embodiment of the disclosure, the greater the value of the default priority and/or the DC-priority, the lower the priority level may be. For example, a field value of 1 (or 0) may indicate the highest priority level. Alternatively, in an embodiment of the disclosure, the greater the value of the default priority and/or the DC-priority, the higher the priority level may be. For example, a field value of 1 (or 0) may indicate the lowest priority level.

In an embodiment of the disclosure, a method by which the base station configures a DC-priority for a logical channel of a UE through an RRC message (e.g., RRCSetup 305, RRCReconfiguration 335, 350) may include at least one of the following options.

In one embodiment of Option 1, one or multiple DC-priorities may be configured for each logical channel. For example, DC-priority may be configured by adding one or multiple DC-priority configuration fields/information (e.g., priorityDelayCritical) to the logical channel configuration information (e.g., LogicalChannelConfig IE). For example, the priorityDelayCritical field may be configured to have a value between P1 and P2 (e.g., INTEGER (P1 . . . . P2)). For instance, P1 may be configured to have a value of 1 or a value greater than 1, and P2 may be configured to have a value of 16, a value greater than 16, or a value less than 16. For example, the DC-priority configuration field (e.g., priorityDelayCritical) may indicate the DC-priority value of the corresponding logical channel. For example, the field/information may indicate a priority offset/difference between the DC-priority and the default priority of the corresponding logical channel. For example, the DC-priority value of the logical channel may be calculated either as (default priority−priority Offset/Difference) or as max (default priority−priority Offset/Difference, 1). For example, an LCH without the DC-priority configuration field configured may be regarded as a logical channel not having a DC-priority configured. For example, with respect to one or multiple logical channels, the DC-priority configuration fields for each logical channel may be collected and included in a single list format (e.g., SEQUENCE (SIZE (1 . . . maxLC-ID)) OF priorityDelayCritical), and this list may be included in cell group configuration information (e.g., CellGroupConfig, MAC-CellGroupConfig) to which the logical channels belong. For example, a DC-priority configuration value to be configured in the priorityDelayCritical IE, and/or an ID (LCID) of a logical channel (LCH) to be configured, and/or a remaining time threshold (e.g., remainingTimeThreshold) to be used as a criterion for determining delay-critical UL data of the LCH may be included as the configuration information. For example, for each LCH, a remaining time threshold for determining delay-critical UL data of the LCH may be configured. For example, the delay-critical UL data may refer to UL data in which a remaining time value of a PDCP discardTimer of a corresponding PDCP service data unit (SDU) is less than or equal to the remaining time threshold.

In one embodiment of Option 2, one or multiple DC-priority fields may be configured for each logical channel group (LCG). For example, when the DC-priority field indicates a DC-priority value, all or some of the logical channels (LCHs) belonging to the configured LCG may be regarded as having the same DC-priority value configured by the DC-priority field. For example, when the DC-priority field indicates a DC-priority offset (e.g., the difference between the default priority and the DC-priority), all or some of the LCHs belonging to the configured LCG may be regarded as having the same DC-priority offset configured by the DC-priority field. For example, the DC-priority value of a specific LCH may be calculated either as (the default priority of the LCH−the DC-priority offset) or as max (the default priority of the LCH−the DC-priority offset, 1). For example, when the DC-priority field is to be applied to some LCHs of the LCG, an indicator indicating one or multiple LCHs to which the DC-priority field is applied may be included. For example, the indicator may be indicated in the form of a list including one or multiple LCIDs of the indicated LCHs (e.g., SEQUENCE (SIZE(1 . . . maxLC-ID)) OF LogicalChannelIdentity), or in the form of a bitmap (e.g., the first bit is assigned to the LCH having the smallest LCID of the LCG, and the remaining bits are assigned in ascending order of LCID, wherein Bit-1 indicates that DC-priority is configured, and Bit-0 indicates that DC-priority is not configured). For example, for each LCG, the DC-priority configuration field may be included in cell group configuration information (e.g., CellGroupConfig, MAC-CellGroupConfig) to which the LCG belongs.

In one embedment of Option 3, one or multiple DC-priority fields may be configured for each cell group. For example, when the DC-priority field indicates a DC-priority value, all or some of the LCHs belonging to the configured cell group may be regarded as having the same DC-priority value configured. For example, when the DC-priority field indicates a DC-priority offset (e.g., the difference between the default priority and the DC-priority), all or some of the LCHs belonging to the configured cell group may be regarded as having the same DC-priority offset configured. For example, the DC-priority value of a specific LCH may be calculated either as (the default priority of the LCH−the DC-priority offset) or as max (the default priority of the LCH−the DC-priority offset, 1). For example, when the DC-priority field is to be applied to some LCHs of the cell group, an indicator indicating one or multiple LCHs to which the DC-priority is to be applied may be included. For example, the indicator may be indicated in the form of a list including one or multiple LCIDs of the indicated LCHs, or one or multiple LCG IDs of the LCGs to which the indicated LCHs belong (e.g., SEQUENCE (SIZE(1 . . . maxLC-ID)) OF LogicalChannelIdentity, SEQUENCE (SIZE(1 . . . maxNrofLCGs-r18)) OF LCG-Id-r18), or in the form of a bitmap (e.g., the first bit is assigned to the LCG/LCH having the smallest LCG ID/LCID in the cell group, and the remaining bits are assigned in ascending order of LCG ID/LCID, wherein Bit-1 indicates that DC-priority is configured, and Bit-0 indicates that DC-priority is not configured). For example, for each cell group, the DC-priority configuration field may be included in the cell group configuration information (e.g., CellGroupConfig, MAC-CellGroupConfig).

In an embodiment of the disclosure, when the base station configures a DC-priority for a specific logical channel, at least one of the following restriction conditions may be applied:
The DC-priority configuration value of a specific logical channel may be restricted to be configured smaller than the default priority configuration value of the logical channel (i.e., to have a higher priority level). For example, the DC-priority configuration value of a specific logical channel may be restricted such that the DC-priority configuration value of the specific logical channel is not configured to be greater than or equal to the default priority configuration value of the logical channel (i.e., to have a lower or equal priority level);
For example, the DC-priority may be restricted such that it may be configured only when the bearer associated with the logical channel is a data radio bearer (DRB). For example, when the bearer associated with the logical channel is a signaling radio bearer (SRB), the DC-priority may be restricted from being configured;
For example, in the case of a logical channel associated with a data radio bearer (DRB), the DC-priority for the logical channel may be restricted to be configured greater than the priority/default priority of logical channels associated with all or some SRBs (e.g., SRB0, SRB1, SRB2, and SRB3) of the same cell group, i.e., to have a lower priority level (e.g., to be configured greater than or equal to the priority of the SRB having the greatest priority value among the SRBs). This restriction may be applied for the purpose of preventing delay-critical UL data of the DRB from interfering with transmission of UL data of the SRB; and/or
In an embodiment, the DC-priority may be restricted such that it may be configured for an LCH only when the LCH belongs to an LCG in which delay status report (DSR) configuration (e.g., LCG-DSR-Config-r18) is included. For example, the DC-priority may be restricted such that it may be configured for an LCG and/or an LCH belonging to the LCG, only when the LCG has a DSR (e.g., LCG-DSR-Config-r18) configured. For example, the DC-priority may be restricted such that it may be configured for a cell group/an LCG belonging to the cell group/an LCH belonging to the cell group, only when the cell group has a DSR (e.g., LCG-DSR-Config-r18) configured.

In an embodiment of the disclosure, the UE may transmit, to a base station, a message for reporting its capability (e.g., UECapabilityInformation) (operation 320). The UE capability reporting message may include an indicator (e.g., dc-priority-r19/priorityDelayCritical-r19/additional-LCH-priority-r19) indicating whether the UE supports DC-priority for the logical channel. For example, when the indicator is configured as “supported,” the base station may regard the UE as supporting DC-priority for the logical channel. For example, when the indicator does not exist, the base station may regard the UE as not supporting DC-priority for the logical channel. For example, the base station may configure a DC-priority for the logical channel of the UE only when the UE supports DC-priority for the logical channel.

In an embodiment of the disclosure, the UE may transmit, to a base station, a message for reporting its capability (e.g., UECapabilityInformation) (operation 320). The UE capability reporting message may include an indicator (information) (e.g., dc-priority-Lcp-r19/priorityDelayCritical-Lcp-r19/additional-LCH-priority-Lcp-r19) indicating whether the UE supports DC-priority for the logical channel with respect to logical channel prioritization (LCP) operation. For example, when the indicator is configured as “supported,” the base station may regard the UE as supporting DC-priority for the logical channel with respect to LCP operation. For example, when the indicator does not exist, the base station may regard the UE as not supporting DC-priority for the logical channel with respect to LCP operation. For example, the base station may configure a DC-priority for the logical channel of the UE only when the UE supports DC-priority for the logical channel with respect to LCP operation. For example, the base station may configure a DC-priority for the logical channel of the UE and instruct the application of DC-priority for the LCP operation only when the UE supports DC-priority for the logical channel with respect to LCP operation.

In an embodiment of the disclosure, a UE may transmit, to a base station, a message for reporting its capability (e.g., UECapabilityInformation) (operation 320). The UE capability reporting message may include an indicator (e.g., dc-priority-Bsr-r19/priorityDelayCritical-Bsr-r19/additional-LCH-priority-Bsr-r19) indicating whether the UE supports DC-priority of a logical channel with respect to buffer status report (BSR) operation. For example, when the indicator is configured as “supported,” the base station may regard the UE as supporting DC-priority for the logical channel with respect to the BSR operation. For example, when the indicator does not exist, the base station may regard the UE as not supporting DC-priority for the logical channel with respect to the BSR operation. For example, the base station may configure the DC-priority for the logical channel of the UE only when the UE supports DC-priority for the logical channel with respect to the BSR operation. For example, the base station may configure the DC-priority for the logical channel of the UE and may instruct the UE to apply the DC-priority with respect to the BSR operation only when the UE supports DC-priority for the logical channel with respect to the BSR operation.

In an embodiment of the disclosure, a UE may transmit, to a base station, a message for reporting its capability (e.g., UECapabilityInformation) (operation 320). The UE capability reporting message may include an indicator (e.g., dc-priority-LCH-BasedPrioritization-r19/priorityDelayCritical-LCH-BasedPrioritization-r19/additional-LCH-priority-LCH-BasedPrioritization-r19) indicating whether the UE supports DC-priority of a logical channel with respect to Ich-BasedPrioritization/intra-UE-Prioritization/intra-CG prioritization operation. For example, when the indicator is configured as “supported,” the base station may regard the UE as supporting DC-priority for the logical channel with respect to the Ich-BasedPrioritization/intra-UE-Prioritization/or intra-CG prioritization operation. For example, when the indicator does not exist, the base station may regard the UE as not supporting DC-priority for the logical channel with respect to the Ich-BasedPrioritization/intra-UE-Prioritization/intra-CG prioritization operation. For example, the base station may configure the DC-priority for the logical channel of the UE only when the UE supports DC-priority for the logical channel with respect to the Ich-BasedPrioritization/intra-UE-Prioritization/intra-CG prioritization operation. For example, the base station may configure the DC-priority for the logical channel of the UE and may instruct the UE to apply the DC-priority with respect to the Ich-BasedPrioritization/intra-UE-Prioritization/intra-CG prioritization operation only when the UE supports DC-priority for the logical channel with respect to the Ich-BasedPrioritization/intra-UE-Prioritization/intra-CG prioritization operation.

In an embodiment of the disclosure, the base station may, based on a capability reporting message received from the UE (operation 320), identify whether the UE supports DC-priority for the logical channel. In an embodiment of the disclosure, the base station may, based on a capability reporting message received from the UE (operation 320), identify whether the UE supports or is capable of applying DC-priority for the logical channel in LCP operation and/or BSR operation and/or Ich-BasedPrioritization/intra-UE-Prioritization/intra-CG prioritization operation.

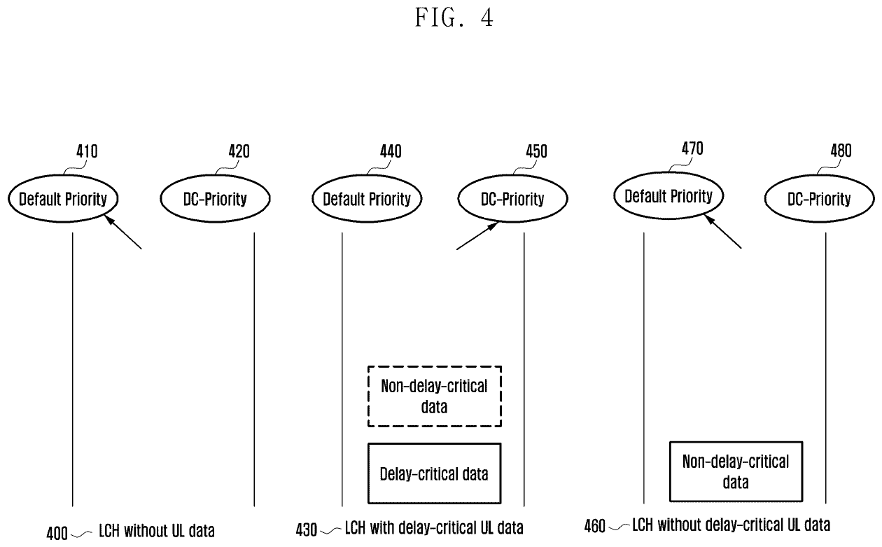

FIG. 4 illustrates an example of a case in which DC-priority is applied to a logical channel according to an embodiment of the disclosure.

Referring to FIG. 4, in LCP and/or BSR and/or Ich-BasedPrioritization/intra-UE-Prioritization/intra-CG prioritization operations, a criterion condition for determining which priority to use, between a default priority and a DC-priority, for a logical channel for which a DC-priority is configured may be at least one of the following cases:
When there is no buffered delay-critical UL (uplink) data in the logical channel (indicated by reference numerals 400, 460), the default priority (410, 470) may be applied to the logical channel for LCP and/or BSR and/or Ich-BasedPrioritization/intra-UE-Prioritization/intra-CG prioritization operations. For example, this may correspond to a case where there is no buffered UL data in the logical channel, and/or a case where there is buffered UL data in the logical channel but no delay-critical UL data;
When there is buffered delay-critical UL data in the logical channel (indicated by reference numeral 430), the DC-priority 450 may be applied to the logical channel. For example, this may correspond to a case where the logical channel contains only delay-critical UL data, and/or a case where the logical channel contains both delay-critical UL data and non-delay-critical UL data. For example, when there is buffered delay-critical UL data in the logical channel, and/or when the base station configures/activates application of DC-priority to LCP operation (e.g., through an RRC message and/or MAC CE), the UE may apply the DC-priority for the logical channel to the LCP operation. For example, when there is buffered delay-critical UL data in the logical channel, and/or when the base station configures/activates application of DC-priority to BSR operation (e.g., through an RRC message and/or MAC CE), the UE may apply the DC-priority for the logical channel to the BSR operation. For example, when there is buffered delay-critical UL data in the logical channel, and/or when the base station configures/activates application of DC-priority to Ich-BasedPrioritization/intra-UE-Prioritization/intra-CG prioritization operation (e.g., through an RRC message and/or MAC CE), the UE may apply the DC-priority for the logical channel to the Ich-BasedPrioritization/intra-UE-Prioritization/intra-CG prioritization operation; and/or
When the DC-priority is not configured, and/or when the remaining time threshold (e.g., remainingTimeThreshold) used for determining delay-critical data is not configured, and/or when DC-priority is deactivated/configured not to be applied for all or some of the LCP/BSR/Ich-BasedPrioritization/intra-UE-Prioritization/intra-CG prioritization operations, the logical channel may apply only the default priority (without applying the DC-priority) for all or some of the LCP/BSR/Ich-BasedPrioritization/intra-UE-Prioritization/intra-CG prioritization operations.

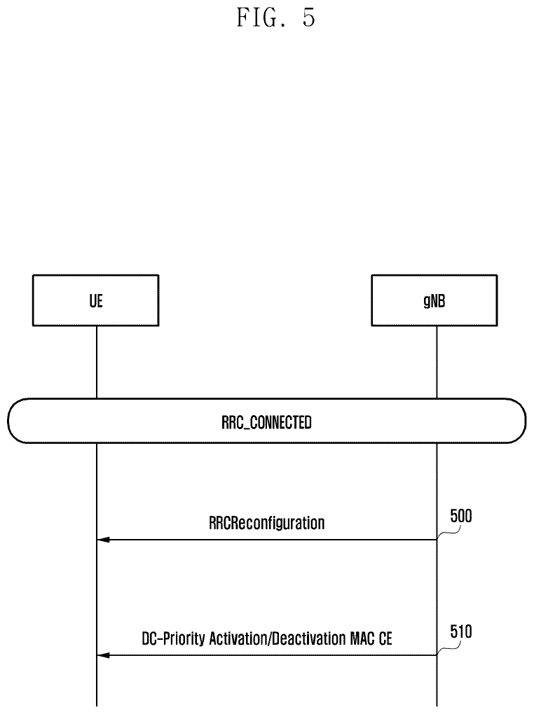

FIG. 5 illustrates an example of an operation in which a base station indicates whether to apply DC-priority to a specific logical channel of a UE according to an embodiment of the disclosure.

Referring to FIG. 5, the base station may transmit an RRC message (e.g., RRCReconfiguration) to a UE in an RRC_CONNECTED state (operation 500), and may configure, for the UE, whether to apply/activate DC-priority to the LCP and/or BSR and/or Ich-BasedPrioritization/intra-UE-Prioritization/intra-CG prioritization operations, for each LCH/LCG/cell group. For example, the instruction may indicate that, when a DC-priority configuration field exists for each LCH/DRB/LCG/cell group, the corresponding LCH/an LCH of the LCG/an LCH of the cell group may be regarded as being able to apply DC-priority (i.e., DC-priority is activated) with respect to the LCP and/or BSR and/or Ich-BasedPrioritization/intra-UE-Prioritization/intra-CG prioritization operations. For example, when a DC-priority configuration field is absent for each LCH/DRB/LCG/cell group, the corresponding LCH/an LCH of the LCG/an LCH of the cell group may be regarded as being unable to apply DC-priority (i.e., DC-priority is deactivated) with respect to the LCP and/or BSR and/or Ich-BasedPrioritization/intra-UE-Prioritization/intra-CG prioritization operations. For example, whether to apply/activate DC-priority to the LCP operation for each LCH/DRB/LCG/cell group may be indicated through a predetermined field (e.g., dc-priority-LCP=activated or deactivated, or deactivated when the field is absent). For example, whether to apply/activate DC-priority to the BSR operation for each LCH/DRB/LCG/cell group may be indicated through a predetermined field (e.g., dc-priority-BSR=activated or deactivated, or deactivated when the field is absent). For example, whether to apply/activate DC-priority to the Ich-BasedPrioritization/intra-UE-Prioritization/intra-CG-prioritization operation for each LCH/DRB/LCG/cell group may be indicated through a predetermined field (e.g., dc-priority-Ich-BasedPrioritization=activated or deactivated, or deactivated when the field is absent).

Referring to FIG. 5, according to an embodiment, the base station may instruct the UE, through a predetermined MAC CE (e.g., dc-priority activation/deactivation MAC CE), whether to apply/activate DC-priority for the LCP operation for each LCH/DRB/LCG/cell group (operation 510). For example, the MAC CE may include one or multiple indicators for each LCH, for each DRB, for each LCG, or for each cell group. The indicator may be a field indicating an LCH ID/DRB ID/LCG ID/cell group ID. The indicator may be in the form of a bitmap indicating a specific LCH/DRB/LCG/cell group by a bit at a specific position. The MAC CE may include an activation (apply DC-priority)/deactivation (do not apply DC-priority) indicator indicating, during LCP operation, whether to apply DC-priority for the LCH/DRB/LCG/cell group indicated by the corresponding LCH/DRB/LCG/cell group indicator. The activation/deactivation indicator may be in the form of a bit, and may indicate activation/deactivation by 1 (activation)/0 (deactivation).

The MAC CE may include an activation (apply DC-priority)/deactivation (do not apply DC-priority) indicator indicating, during BSR operation, whether to apply DC-priority for the LCH/DRB/LCG/cell group indicated by the corresponding LCH/DRB/LCG/cell group indicator. The activation/deactivation indicator may have a bit format and may indicate activation/deactivation by 1 (activation)/0 (deactivation).

The MAC CE may include an activation (apply DC-priority)/deactivation (do not apply DC-priority) indicator indicating, during the Ich-BasedPrioritization/intra-UE-Prioritization/intra-CG prioritization operation, whether to apply DC-priority for the LCH/DRB/LCG/cell group indicated by the corresponding LCH/DRB/LCG/cell group indicator. The activation/deactivation indicator may have a 1-bit format and may indicate activation/deactivation by 1 (activation)/0 (deactivation).

In an embodiment of the disclosure, when DC-priority is activated for application to the LCP/BSR/Ich-BasedPrioritization/intra-UE-Prioritization/intra-CG prioritization, the activation state may be maintained until it is deactivated.

In an embodiment of the disclosure, when DC-priority is deactivated for application to the LCP/BSR/Ich-BasedPrioritization/intra-UE-Prioritization/intra-CG prioritization, the deactivation state may be maintained until it is activated.

In an embodiment of the disclosure, in order to prioritize the service of delay-critical UL data, when the base station activates DC-priority for application to the BSR operation and/or configures DC-priority for the BSR operation with respect to a specific MAC entity, cell group, LCG, or LCH of the UE, the UE may perform at least one of the following operations:
When a specific LCH belongs to an LCG and new UL data is available in the LCH, if the priority of the LCH is higher than the priorities of other LCHs within the LCG including the available UL data, a BSR may be triggered. For example, in comparing priorities among LCHs, DC-priority may be applied to an LCH including delay-critical UL data, while a default priority may be applied to an LCH not including delay-critical UL data;
The MAC entity may, with respect to a BSR triggered by expiration of a retxBSR-Timer, regard the LCH having UL data and the highest priority in the priority comparison among the LCHs as being triggered. For example, in the priority comparison, DC-priority may be applied to an LCH including delay-critical UL data, while a default priority may be applied to an LCH not including delay-critical UL data;
When transmitting a padding BSR, if a MAC entity in which logicalChannelGroupIAB-Ext is not configured has a number of padding bits greater than the size of a short BSR including its subheader and smaller than the size of a long BSR including its subheader, and when the padding BSR is generated, there is data to be transmitted in two or more LCGs, and if the number of padding bits is equal to the size of the short BSR including its subheader, the MAC entity may report a short truncated BSR for the LCG to which an LCH having the highest priority among the LCHs with data to be transmitted belongs. For example, when determining the LCH having the highest priority, DC-priority may be applied to an LCH including delay-critical UL data, while a default priority may be applied to an LCH not including delay-critical UL data; and/or
When transmitting a padding BSR, if a MAC entity in which logicalChannelGroupIAB-Ext is not configured has a number of padding bits greater than the size of a short BSR including its subheader and smaller than the size of a long BSR including its subheader, and if, at the time of generating the padding BSR, there is data to be transmitted in two or more LCGs, and if the number of padding bits is not equal to the size of the short BSR including its subheader, the MAC entity may select an LCG to be reported among LCGs including an LCH having data to be transmitted, in a decreasing priority order from the highest LCH priority (regardless of whether there is data to be transmitted) (LCGs having the same highest LCH priority are ordered in ascending order of LCG ID), and may report a long truncated BSR for the selected LCG. For example, when determining the highest LCH priority of a specific LCG, DC-priority may be applied to an LCH including delay-critical UL data, while a default priority may be applied to an LCH not including delay-critical UL data.

In an embodiment of the disclosure, in order to prioritize the service of delay-critical UL data, when the base station activates DC-priority for application to LCP operation and/or configures DC-priority for LCP operation with respect to a specific MAC entity, cell group, LCG, or LCH of the UE, the UE may perform the LCP operation as follows:
Procedure 1: When a new UL transmission is performed, the MAC entity may allocate resources to each LCH as follows. LCHs selected in clause 5.4.3.1.2 of TS 38.321 for the UL grant with Bj>0 are allocated resources in a decreasing order. For example, if the prioritized bit rate (PBR) of a specific LCH is set to infinity, the MAC entity may allocate resources for all the data that is available for transmission on the LCH before meeting the PBR of the lower priority LCH(s). For example, in the LCH priority comparison of Procedure 1, DC-priority may be applied to an LCH including delay-critical UL data, while a default priority may be applied to an LCH not including delay-critical UL data. For example, in the LCH priority comparison of Procedure 1, at the time of starting Procedure 1/LCP operation, DC-priority may be applied to an LCH including delay-critical UL data, while at the time of starting Procedure 1/LCP operation, a default priority may be applied to an LCH not including delay-critical UL data;
Procedure 2: Bj may be decremented by the total size of MAC SDUs served to logical channel j above; and
Procedure 3: If any resources remain, all LCHs selected in clause 5.4.3.1.2 of TS 38.321 may be allocated resources in a strict decreasing order of LCH priority (regardless of the value of Bj) until either the data for the LCH or the UL grant is exhausted. For example, LCHs with equal applied LCH priority may be served equally. For example, in the LCH priority comparison, DC-priority may be applied to an LCH including delay-critical UL data, while a default priority may be applied to an LCH not including delay-critical UL data. For example, in the LCH priority comparison of Procedure 3, at the start of procedure 3, at the start of procedures 1 and 3, or at the start of procedure 1/LCP operation, DC-priority may be applied to an LCH including delay-critical UL data, while in the LCH priority comparison of Procedure 3, at the start of procedure 3, at the start of procedures 1 and 3, or at the start of procedure 1/LCP operation, the priority (default priority) may be applied to an LCH not having delay-critical UL data.

In an embodiment of the disclosure, in order to prioritize the service of delay-critical UL data, when the base station activates DC-priority for application to intra-UE prioritization, intra-CG prioritization, or LCH-based prioritization operation and/or configures DC-priority for intra-UE prioritization/intra-CG prioritization/LCH-based prioritization operation with respect to a specific MAC entity/cell group/LCG/LCH of the UE, the UE may perform at least one of the following operations:
For configured uplink grants configured with cg-RetransmissionTimer, the UE implementation selects an HARQ Process ID among the HARQ process IDs available for the configured grant configuration. If the MAC entity is configured with intraCG-Prioritization, for HARQ Process ID selection, the UE may prioritize the HARQ Process ID with the highest priority, where the priority of a HARQ process is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to the mapping restrictions described in clause 5.4.3.1.2 of TS 38.321. If the MAC entity is configured with intraCG-Prioritization, for HARQ Process ID selection among initial transmission and retransmission with equal priority, the UE may prioritize retransmissions before initial transmissions. The priority of a HARQ Process for which no data for logical channels is multiplexed or can be multiplexed in the MAC PDU is lower than the priority of a HARQ Process for which data for any logical channels is multiplexed or can be multiplexed in the MAC PDU. If the MAC entity is not configured with intraCG-Prioritization, for HARQ Process ID selection, the UE may prioritize retransmissions before initial transmissions. The UE may toggle the NDI in the CG-UCI for new transmissions and may not toggle the NDI in the CG-UCI in retransmissions. For example, when determining the priority of the HARQ process, in the process of configuring the priority to that of the LCH having the highest priority, in the comparison of the priorities among the LCHs, DC-priority (if configured and/or activated) may be applied to an LCH including delay-critical UL data, while a default priority may be applied to an LCH not including delay-critical UL data; and/or.
For the MAC entity configured with Ich-basedPrioritization, the priority of an uplink grant is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to the mapping restrictions described in clause 5.4.3.1.2 of TS 38.321. The priority of an uplink grant for which no data for logical channels is multiplexed or can be multiplexed in the MAC PDU is lower than either the priority of an uplink grant for which data for any logical channels is multiplexed or can be multiplexed in the MAC PDU or the priority of the logical channel triggering an SR. For example, when determining the priority of a UL grant, in the process of configuring the priority to that of the LCH being multiplexed or to be multiplexed and having the highest priority, in the comparison of priorities among the LCHs, DC-priority (if configured and/or activated) may be applied to an LCH including delay-critical UL data, while a default priority may be applied to an LCH not including delay-critical UL data. For example, when determining the priority of an LCH that has triggered an SR, DC-priority (if configured and/or activated) may be applied to an LCH including delay-critical UL data, while a default priority may be applied to an LCH not including delay-critical UL data.

In an embodiment of the disclosure, the types (type, format) of delay-critical UL data used for DSR reporting/triggering of a specific LCH/LCG and/or for the DC-priority application conditions of the disclosure may include one or more of the following types:
Delay-critical PDCP SDU: if pdu-SetDiscard is not configured, a PDCP SDU for which the remaining time till discardTimer expiry is less than the remainingTimeThreshold. If pdu-SetDiscard is configured, a PDCP SDU belonging to a PDU Set of which at least one PDCP SDU has the remaining time till discardTimer expiry less than the remainingTimeThreshold;
the delay-critical PDCP SDUs for which no PDCP data PDUs have been constructed;
the PDCP data PDUs that contain the delay-critical PDCP SDUs and have not been submitted to lower layers;
delay-critical RLC SDUs and delay-critical RLC SDU segments that have not yet been included in an RLC data PDU, where Delay-critical RLC SDU is defined as the RLC SDU corresponding to a PDCP PDU indicated as delay-critical by PDCP (see TS 38.323).
RLC data PDUs pending for initial transmission, and containing a delay-critical RLC SDU or a delay-critical RLC SDU segment;
A PDCP SDU that has not been transmitted in any MAC PDU and is a delay-critical PDCP SDU associated with the logical channel;
RLC data PDUs that are pending for retransmission (RLC AM);
Estimated RLC STATUS PDU if it has been triggered, when t-StatusProhibit is not running or has expired;
the PDCP Control PDUs;
for AM DRBs, the PDCP SDUs to be retransmitted according to TS 38.323 clause 5.1.2 and clause 5.13
for AM DRBs, the PDCP data PDUs to be retransmitted according to TS 38.323 clause 5.5
the (non-delay-critical) PDCP SDU(s) with a PDCP COUNT/sequence number (SN) value smaller than [at least one]/[any]/[last]/[of largest COUNT/SN] delay-critical PDCP SDU(s), for which no PDCP data PDUs have been constructed; the corresponding PDCP SDU that has not yet been constructed into a PDCP data PDU when there exists a delay-critical PDCP SDU having a larger COUNT/SN than that of a specific (non-delay-critical) PDCP SDU, or when there exists a delay-critical PDCP SDU that arrives later at the PDCP entity than a specific (non-delay-critical) PDCP SDU; and/or
the PDCP data PDUs that contain the (non-delay-critical) PDCP SDU(s) with a PDCP COUNT/SN (Sequence Number) value smaller than that of [at least one]/[any]/[last]/[of largest COUNT/SN] delay-critical PDCP SDU(s), and have not been submitted to lower layers; the PDCP data PDU including the corresponding PDCP SDU that has not yet been delivered to a lower layer when there exists a delay-critical PDCP SDU having a larger COUNT/SN than that of a specific (non-delay-critical) PDCP SDU, or when a delay-critical PDCP SDU that arrives later at the PDCP entity than a specific (non-delay-critical) PDCP SDU exists.

In an embodiment of the disclosure, in at least one of the following cases, the PDCP entity of a UE/base station may provide a delay-critical indication for a specific PDCP data PDU to a lower layer entity (e.g., RLC entity, MAC entity) within the same device:
When a specific PDCP SDU is regarded as a delay-critical PDCP SDU and the corresponding PDCP data PDU has already been delivered to a lower layer (e.g., an RLC entity), a delay-critical indication may be provided for the corresponding PDCP data PDU;
When a PDCP data PDU corresponding to a delay-critical PDCP SDU or corresponding to the PDCP SDU that is regarded as the delay-critical PDCP SDU is delivered to a lower layer (e.g., an RLC entity), a delay-critical indication may be provided for the corresponding PDCP data PDU;
When a specific PDCP SDU is regarded as a delay-critical PDCP SDU and the corresponding PDCP data PDU has already been delivered to the lower layer (e.g., an RLC entity), or when the corresponding PDCP data PDU is being delivered to a lower layer, a delay-critical indication may be provided for the corresponding PDCP data PDU;
When a delay-critical PDCP SDU having a larger COUNT/SN than that of a specific PDCP SDU exists, or when a delay-critical PDCP SDU that arrives later at the PDCP entity than a specific PDCP SDU exists, and the PDCP data PDU corresponding to the specific PDCP SDU has already been delivered to a lower layer (e.g., an RLC entity), a delay-critical indication may be provided for the corresponding PDCP data PDU; and
When a delay-critical PDCP SDU having a larger COUNT/SN than that of a specific PDCP SDU exists, or when a delay-critical PDCP SDU that arrives later at the PDCP entity than a specific PDCP SDU exists, and the PDCP data PDU corresponding to the specific PDCP SDU is being delivered to a lower layer (e.g., an RLC entity), a delay-critical indication may be provided for the corresponding PDCP data PDU.

In an embodiment of the disclosure, as a condition for applying DC-priority in the BSR and/or LCP and/or intra-UE prioritization/intra-CG prioritization/LCH-based prioritization operations, a remaining time threshold (e.g., remainingTimeThreshold) used as a criterion for delay-critical UL data of a specific LCH/LCG (e.g., the remaining PDCP discardTimer time being smaller than or equal to a specific threshold) may be equal to (or directly applied without change from) the remainingTimeThreshold-r18 included in the LCG to which the LCH belongs and/or the DSR configuration (e.g., LCG-DSR-Config-r18) configured for the LCG.

In an embodiment of the disclosure, as a condition for applying DC-priority in the BSR and/or LCP and/or intra-UE prioritization/intra-CG prioritization/Ich-BasedPrioritization operations, a remaining time threshold (e.g., remainingTimeThreshold) used as a criterion for delay-critical UL data of a specific LCH/LCG (e.g., the remaining PDCP discardTimer time being less than, or less than and equal to, a specific threshold) may be a separate threshold different from the remaining TimeThreshold-r18 included in the DSR configuration (e.g., LCG-DSR-Config-r18) configured for the LCG to which the LCH belongs and/or the DSR configuration configured for the corresponding LCG. For example, the threshold may be configured for each LCH/LCG/DRB/MAC entity/cell group, and/or for each of the BSR and/or LCP and/or intra-UE prioritization/intra-CG prioritization/Ich-BasedPrioritization operations.

In an embodiment of the disclosure, for each LCH/LCG, separate DC-priorities may be configured respectively for each of the BSR and/or LCP and/or intra-UE prioritization/intra-CG prioritization/Ich-based prioritization operations (e.g., configuring a DC-priority applied to the BSR, a DC-priority applied to the LCP, and a DC-priority applied to intra-UE prioritization, respectively). For example, when delay-critical UL data exists in the corresponding LCH and/or LCG, the DC-priorities applied to the BSR and/or LCP and/or intra-UE prioritization/intra-CG prioritization/Ich-based prioritization operations may be different from each other and may each be configured separately.

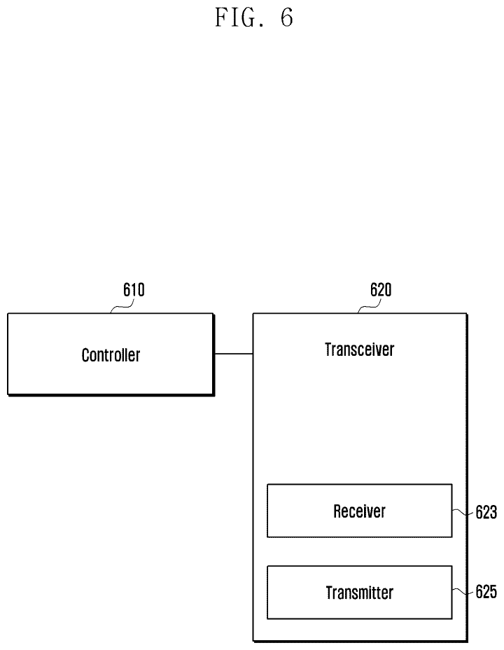

FIG. 6 illustrates an example of a structure of a UE according to an embodiment of the disclosure.

Referring to FIG. 6, the UE according to an embodiment of the disclosure may include a transceiver 620 and a controller 610 that controls the overall operation of the UE. Also, the transceiver 620 may include a transmitter 625 and a receiver 623.

The transceiver 620 may transmit/receive signals with other network entities.

The controller 610 may control the UE to perform the operations according to any one of the above-described embodiments. The controller 610 and the transceiver 620 are not necessarily implemented as separate modules, but may be implemented as a single component unit such as a single chip. Also, the controller 610 and the transceiver 620 may be electrically connected to each other. In addition, the controller 610 may be, for example, a circuit, an application-specific circuit, or at least one processor. Moreover, the operations of the UE may be implemented by providing any unit in the UE with a memory device storing corresponding program codes.

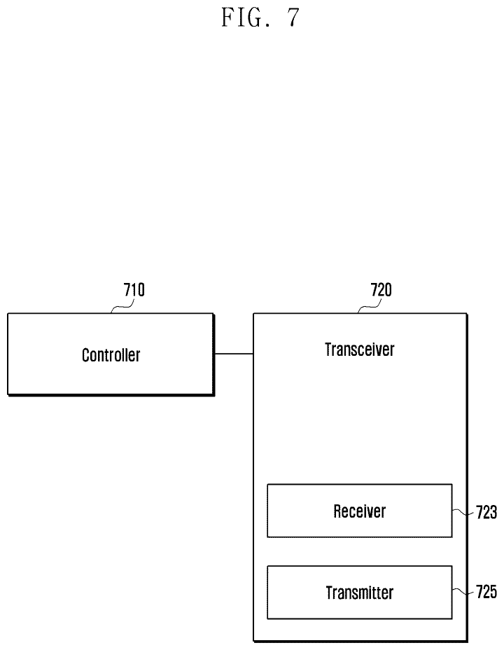

FIG. 7 illustrates an example of a structure of a base station according to an embodiment of the disclosure.

Referring to FIG. 7, the base station according to an embodiment of the disclosure may include a transceiver 720 and a controller 710 that controls the overall operation of the base station. Also, the transceiver 720 may include a transmitter 725 and a receiver 723.

The transceiver 720 may transmit/receive signals with UEs or other network entities.

The controller 710 may control the base station to perform the operations according to any one of the above-described embodiments. The controller 710 and the transceiver 720 are not necessarily implemented as separate modules, but may be implemented as a single component unit such as a single chip. Also, the controller 710 and the transceiver 720 may be electrically connected to each other. In addition, the controller 710 may be, for example, a circuit, an application-specific circuit, or at least one processor. Moreover, the operations of the base station may be implemented by providing any unit in the base station with a memory device storing corresponding program codes.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, the respective embodiments of the disclosure may be at least partially combined with each other to be operated by a base station, a terminal, or a specific network entity.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It should be noted that the configuration diagrams, illustrative diagrams of control/data signal transmission methods, illustrative diagrams of operation procedures, and structural diagrams as illustrated in FIG. 1 to FIG. 7 are not intended to limit the scope of protection of the disclosure. That is, all the constituent units, entities, or operation steps shown in FIG. 1 to FIG. 7 should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units and modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a message comprising information on a priority for a logical channel, information on an additional priority for the logical channel, and information on a threshold for determining whether the additional priority is applied for the logical channel;
determining whether a remaining time of a packet data convergence protocol (PDCP) service data unit (SDU) of the logical channel is less than the threshold; and
in case that the remaining time of the PDCP SDU of the logical channel is less than the threshold, applying the additional priority of the logical channel.

2. The method of claim 1, wherein the applying the additional priority further comprises:
allocating resources to logical channels with Bj>0 in a decreasing priority order, wherein the Bj is a variable for a logical channel j;
decreasing the Bj by a total size of medium access control (MAC) SDUs served to the logical channel j;
in case that any resource remain, determining whether the logical channel does not have any uplink data having the remaining time before discard falling below the threshold;
in case that the logical channel does not have any uplink data having the remaining time before discard falling below the threshold, applying the priority of the logical channel; and
allocating resources to logical channels in a strict deceasing priority order regardless of the Bj until either a data for a logical channel or an uplink grant is exhausted.

3. The method of claim 1, wherein the receiving the message further comprises:
transmitting, to the base station, information indicating that the terminal supports the additional priority for the logical channel.

4. The method of claim 1, wherein the information on the priority, the information on the additional priority, and the information on the threshold are included in logical channel configuration information.

5. A method performed by a base station in a wireless communication system, the method comprising:
transmitting, to a terminal, a message comprising information on a priority for a logical channel, information on an additional priority for the logical channel, and information on a threshold for determining whether the additional priority is applied for the logical channel; and
receiving, from the terminal, uplink data based on a priority order of logical channels,
wherein, in case that a remaining time of a packet data convergence protocol (PDCP) service data unit (SDU) of the logical channel is less than the threshold, the additional priority of the logical channel is applied.

6. The method of claim 5, wherein logical channels with Bj>0 are allocated resources in a decreasing priority order, the Bj is a variable for a logical channel j, and the Bj is decreased by a total size of medium access control (MAC) SDUs served to the logical channel j,
wherein, in case that any resource remain and the logical channel does not have any uplink data having the remaining time before discard falling below the threshold, the priority of the logical channel is applied, and
wherein logical channels are allocated resources in a strict deceasing priority order regardless of the Bj until either a data for a logical channel or an uplink grant is exhausted.

7. The method of claim 5, wherein the transmitting the message further comprises:
receiving, from the terminal, information indicating that the terminal supports the additional priority for the logical channel.

8. The method of claim 5, wherein the information on the priority, the information on the additional priority, and the information on the threshold are included in logical channel configuration information.

9. A terminal in a wireless communication system, the terminal comprising:
a transceiver; and
a controller coupled with the transceiver and configured to:
receive, from a base station, a message comprising information on a priority for a logical channel, information on an additional priority for the logical channel, and information on a threshold for determining whether the additional priority is applied for the logical channel,
determine whether a remaining time of a packet data convergence protocol (PDCP) service data unit (SDU) of the logical channel is less than the threshold, and
in case that the remaining time of the PDCP SDU of the logical channel is less than the threshold, apply the additional priority of the logical channel.

10. The terminal of claim 9, wherein the controller is further configured to:
allocate resources to logical channels with Bj>0 in a decreasing priority order, wherein the Bj is a variable for a logical channel j,
decrease the Bj by a total size of medium access control (MAC) SDUs served to the logical channel j,
in case that any resource remain, determine whether the logical channel does not have any uplink data having the remaining time before discard falling below the threshold,
in case that the logical channel does not have any uplink data having the remaining time before discard falling below the threshold, apply the priority of the logical channel, and
allocate resources to logical channels in a strict deceasing priority order regardless of the Bj until either a data for a logical channel or an uplink grant is exhausted.

11. The terminal of claim 9, wherein the controller is further configured to:
transmit, to the base station, information indicating that the terminal supports the additional priority for the logical channel.

12. The terminal of claim 9, wherein the information on the priority, the information on the additional priority, and the information on the threshold are included in logical channel configuration information.

13. A base station in a wireless communication system, the base station comprising:
a transceiver; and
a controller coupled with the transceiver and configured to:
transmit, to a terminal, a message comprising information on a priority for a logical channel, information on an additional priority for the logical channel, and information on a threshold for determining whether the additional priority is applied for the logical channel, and
receive, from the terminal, uplink data based on a priority order of logical channels,
wherein, in case that a remaining time of a packet data convergence protocol (PDCP) service data unit (SDU) of the logical channel is less than the threshold, the additional priority of the logical channel is applied.

14. The base station of claim 13, wherein logical channels with Bj>0 are allocated resources in a decreasing priority order, the Bj is a variable for a logical channel j, and the Bj is decreased by a total size of medium access control (MAC) SDUs served to the logical channel j,
wherein, in case that any resource remain and the logical channel does not have any uplink data having the remaining time before discard falling below the threshold, the priority of the logical channel is applied, and
wherein logical channels are allocated resources in a strict deceasing priority order regardless of the Bj until either a data for a logical channel or an uplink grant is exhausted.

15. The base station of claim 13, wherein the controller is further configured to:
receive, from the terminal, information indicating that the terminal supports the additional priority for the logical channel.

16. The base station of claim 13, wherein the information on the priority, the information on the additional priority, and the information on the threshold are included in logical channel configuration information.
